(19) United States
(12) Patent Application Publication
(10) Pub. No.: US 2011/0247181 A1
(43) Pub. Date: Oct. 13, 2011

(54) FASTENER

(75) Inventor: CHI-CHING LIN, TAIPEI CITY (TW)

(73) Assignees: MASCO ENTERPRISE CO., LTD., TAIPEI CITY (TW); CORTINA GLOBAL CORPORATION, TAIPEI CITY (TW)

(21) Appl. No.: 12/757,373

(22) Filed: Apr. 9, 2010

(51) Int. Cl. F16B 2/20

(52) U.S. Cl. 24/455

(57) ABSTRACT

A fastener for coupling a first object and a second object comprises a base, a bending portion and a through hole. The base includes a hole and binds with the first object by a fixing component passing through the hole. One end of the bending portion is extended from the base in a curved U shape. The bending portion has a plurality of ribs, and one end of the bending portion warps away from the base. The through hole is formed between the base and the bending portion. The second object is disposed in the through hole by bending the bending portion away from the base to expand the bending portion outward. The bending portion clamps the second object when the bending portion is released to its original state. Therefore, the fastener can bind and separate the helmet and the mask without any assistance of a tool.

### BACKGROUND OF THE INVENTION

1. Field of the Invention

The present invention relates to a fastener, and more particularly to a fastener for coupling and separating a first object and a second object conveniently.

2. Description of the Related Art

Baseball or softball catchers are usually impacted by a high-speed ball coming from a front side of the catchers in a ball game. Therefore, wearing a sporting helmet is necessary to prevent direct impacts at the front side of the face of athletes. With reference to FIG. 1 for a schematic view of a conventional sporting helmet, the conventional sporting helmet comprises a helmet body 51 worn at the head of wearer and a protecting mask 52 mounted at a frond side of the helmet body for guarding the face of the wearer. The protecting mask 52 includes an outer frame 521 mounted at the helmet body 51 and a plurality of bars 522 installed on the outer frame to fit the face of the wearer.

To stabilize the latching effect, fasteners and corresponding rivets are usually used for connecting the helmet body 51 and the protecting mask 52 in the conventional sporting helmet.

However, it takes a lot of time to engage the helmet body 51 and the outer frame 521 by using the rivets one by one in a conventional assembling process.

Besides, if the wearer is injured, a tool such as a screwdriver will be required to separate the helmet body 51 and the protecting mask 52, thus delaying the rescue time and causing inconvenience.

### SUMMARY OF THE INVENTION

Therefore, it is a primary objective of the present invention to provide a fastener for assembling and detaching a helmet and a mask conveniently.

To achieve the foregoing objective, the present invention applies a fastener for coupling a first object and a second object. The fastener comprises a base, a bending portion and a through hole. The base is engaged with the first object. The bending portion is extended curvedly from one end of the base. The through hole is formed between the base and the bending portion. The second object is disposed in the through hole by bending the bending portion away from the base, so as to expand the bending portion outward. The bending portion clamps the second object when the bending portion is restored to its original state.

The base further comprises a stopping portion projecting from one side of the base to the through hole.

The fastener further comprises a plate body made of metal and disposed on one side of the base, and one end of the bending portion extended to one side of the plate body.

The plate body includes a plurality of dots disposed on one side of the plate body, and the dots are in contact with the base.

The plate body further includes a limiting hole corresponding to the hole, and a fixing component protruded to the constraining hole.

The base and the bending portion are made of nylon or ion-polymerized resin (surlyn).

To achieve the forging objective, the present invention applies a fastener for coupling a first object and a second object. The first object is a helmet, and the second object is a mask. The fastener comprises a base, a bending portion and a through hole. The base includes a hole and a stopping portion, and the base engages the first object with a fixing component passing through the hole. The stopping portion is projecting from one side of the base to the through hole. The bending portion has a plurality of ribs, and one end of the bending portion extends from one end of the base in a curved U-shape. The through hole is formed between the base and the bending portion. The second object is disposed in the through hole by bending the bending portion away from the base to expand the bending portion outward, and the bending portion clamps the second object when the bending portion is restored to its original state.

The fastener further comprises a plate body made of metal and disposed on one side of the base, and one end of the bending portion extended to one side of the plate body.

The plate body includes a plurality of dots disposed on one side of the plate body, and the dots are in contact with the base.

The plate body further comprises a limiting hole corresponding to the hole, and the fixing component is protruded into the limiting hole.

The base and the bending portion are made of nylon or ion-polymerized resin (surlyn).

To achieve the other forgoing objective, the present invention applies a fastener for coupling a first object and a second object. The fastener comprises a base, a bending portion, a plate body and a through hole. The base has a hole, a stopping portion and a limiting hole. The base engages the first object with a fixing component passing through the hole. The stopping portion projecting from one side of the base to the through hole which corresponds to the limiting hole, and the fixing component is protruded into the limiting hole. The bending portion is extended from on end of the base in a curved U-shape. The bending portion includes a plurality of ribs, and one end of the bending portion is warped away from the base. The plate body made of metal is disposed on one side of the base, and one end of the bending portion is extended to one side of the base plate. The through hole is formed between the base and the bending portion. The second object is disposed in the through hole by bending the bending portion away from the base to expand the bending portion outward, and then the bending portion clamps the second object when the bending portion is restored to its original state.

The plate body includes a plurality of dots disposed on one side of the plate body, and the dots are in contact with the base.

The first object is a helmet, and the second object is a mask.

### BRIEF DESCRIPTION OF THE DRAWINGS

FIG. 1 is a schematic view of a conventional sporting helmet.

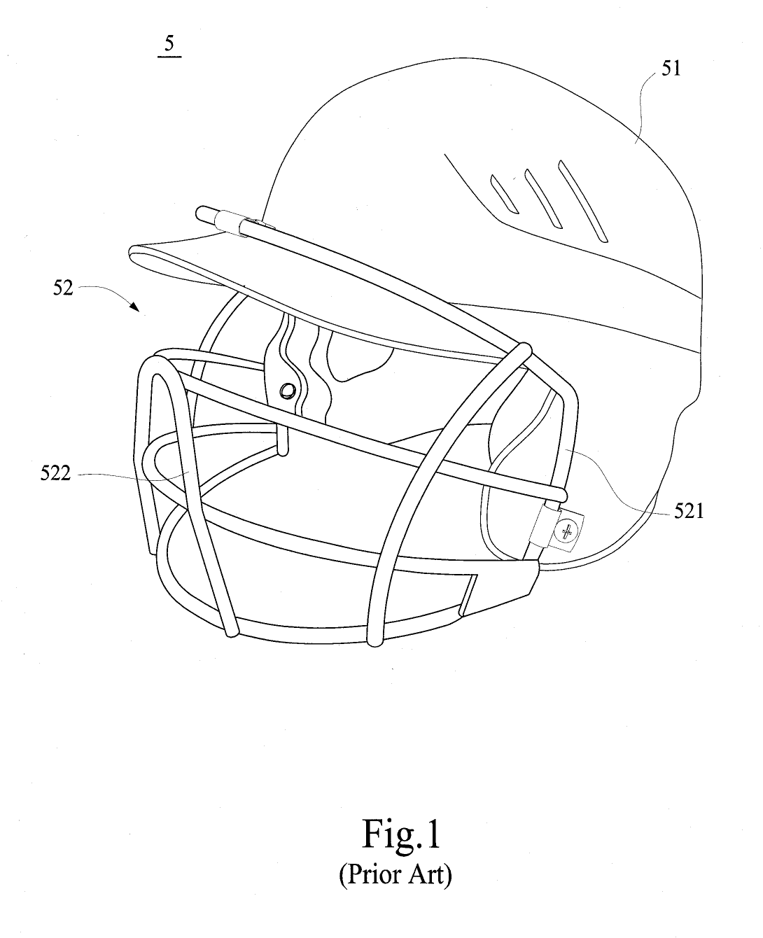

FIG. 2 is an exploded view of a fastener in accordance with a preferred embodiment of the present invention.

FIG. 3 is a sectional view of a fastener in accordance with a preferred embodiment of the present invention.

FIG. 4 is a first schematic view of a fastener in accordance with a first preferred embodiment of the present invention.

FIG. 5 is a second schematic view of a fastener in accordance with a first embodiment of the present invention.

FIG. 6 is a schematic view detaching a fastener in accordance with present invention.

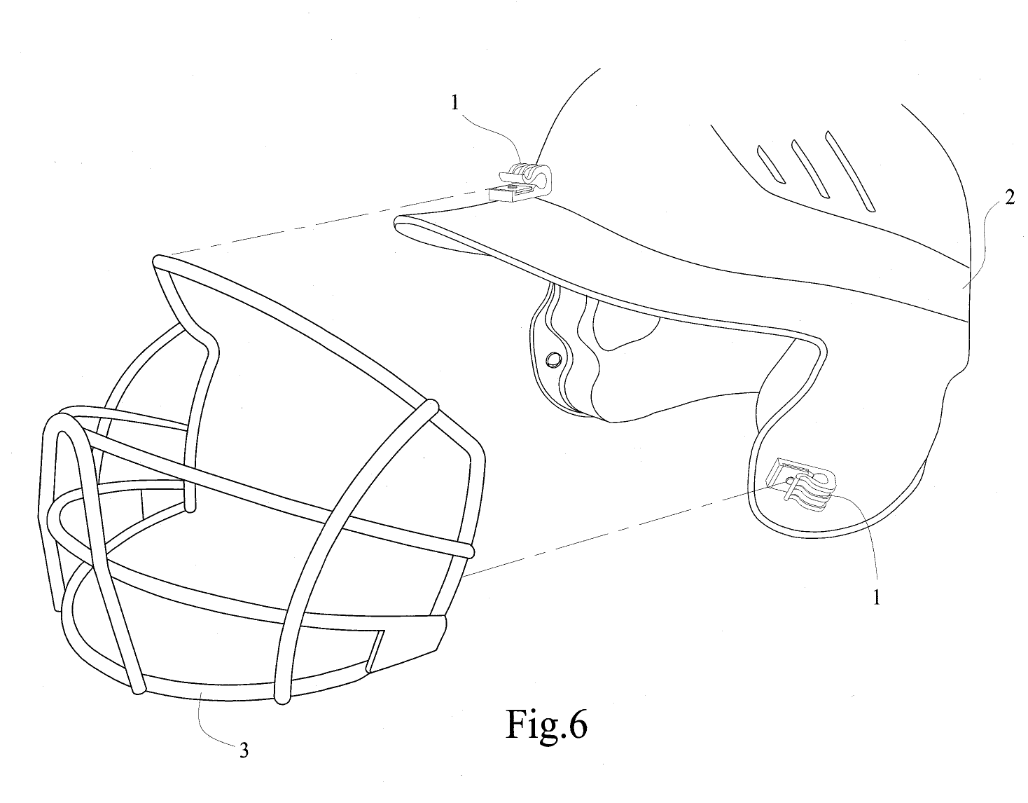

FIG. 7 is an exploded view of a fastener, schematically showing a way of coupling the fastener in accordance with a second preferred embodiment of the present invention.

FIG. 8 is a perspective view of a fastener in accordance with a second preferred embodiment of the present invention.

### DETAILED DESCRIPTION OF THE PREFERRED EMBODIMENTS

The technical characteristics of the present invention will become apparent with the detailed description of the preferred embodiments and the illustration of the related drawings.

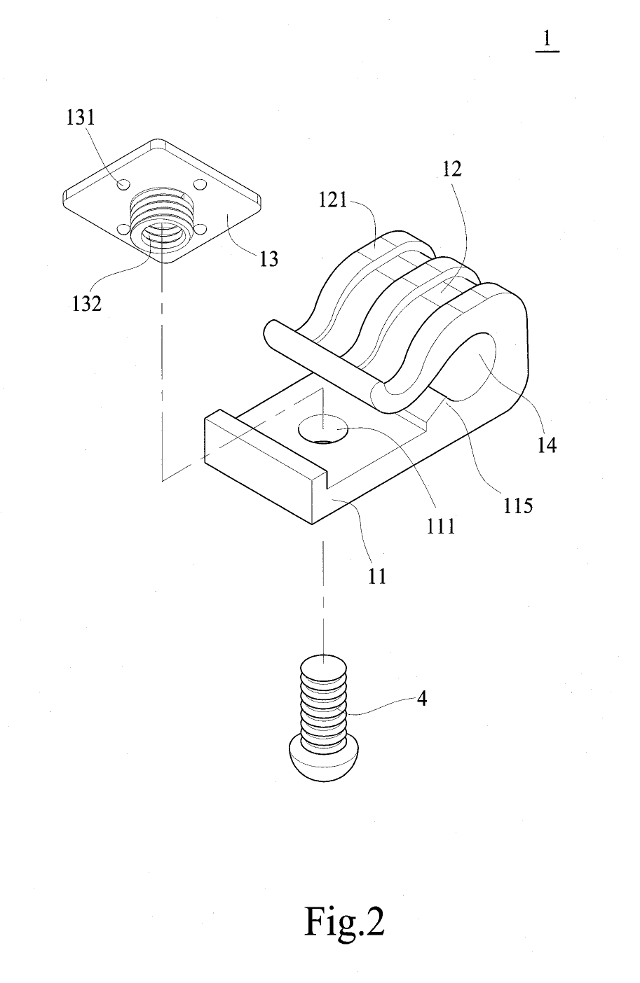

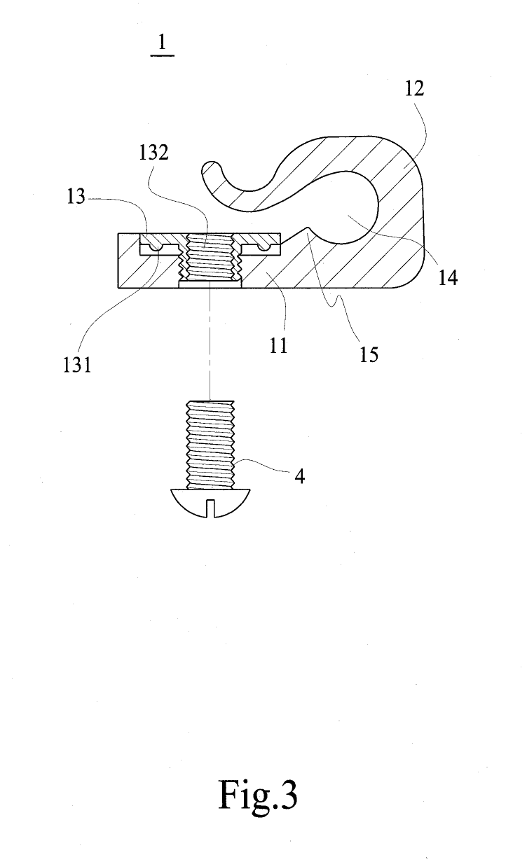

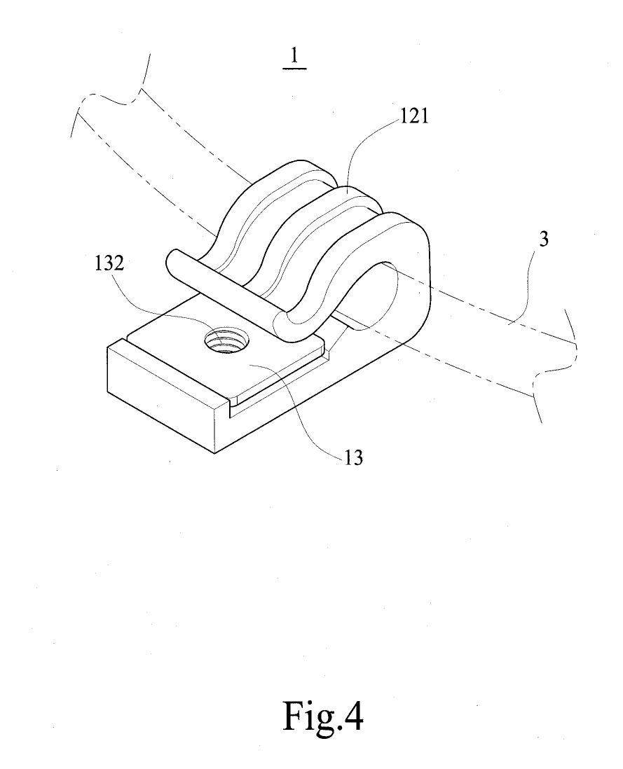

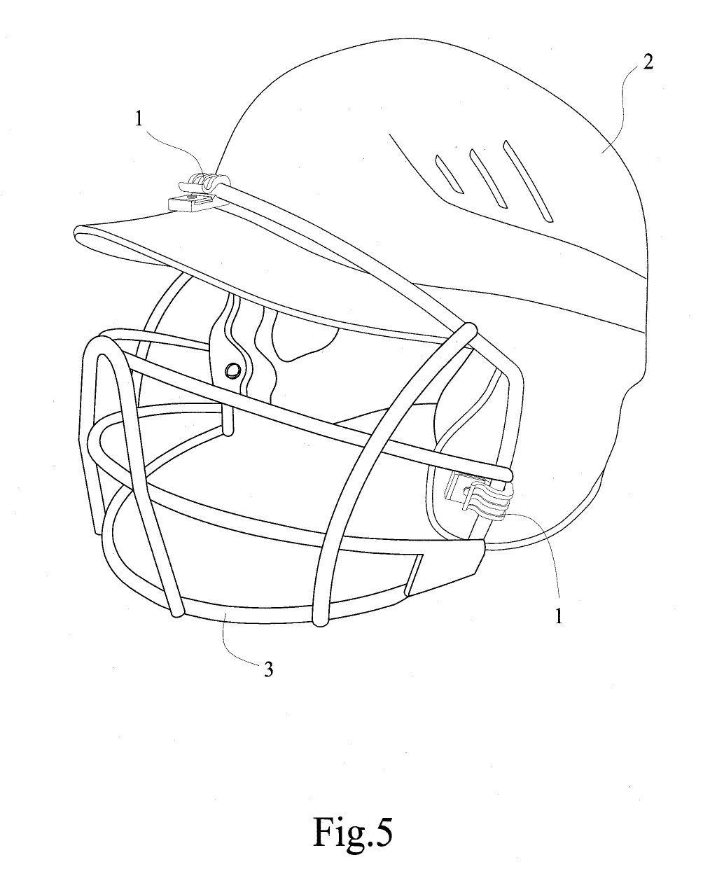

With reference to FIGS. 2, 3, 4, 5 for an exploded view, a sectional view, first and second assemble views showing a first embodiment of the present invention respectively, the fastener 1 is used for coupling a first object 2 and a second object 3. In this embodiment, the first object 2 is a helmet, and the second object 3 is a mask, but the present invention is not limited thereto.

The fastener 1 comprises a base 11, a bending portion 12, a plate body 13 and a through hole 14. The base 11 is made of plastic and includes a hole 111. The base 11 further includes a stopping portion 115 projecting from one side of the base 11 to the through hole 14.

The bending portion 12 made of plastic is extended from one end of the base 11 in a curved U-shape. The bending portion 12 includes a plurality of ribs 121, and one end of the bending portion 12 is warped away from the base 11 for users to operate. Wherein the ribs 121 are disposed parallel to the extended direction of the bending portion 12, and the ribs 121 are integrally formed with the bending portion 12, so as to reinforce the bending portion 12 to prevent the bending portion 12 from being broken by forces.

The through hole 14 corresponded to the second object 3 is formed between the base 11 and the bending portion 12.

The plate body 13 made of metal is disposed on one side of the base 11, and one end of the bending portion 12 is extended to one side of the plate body 13. Besides, the plate body 13 further comprises a plurality of dots 131 and a limiting hole 132. The dots 131 located on one side of the plate body 13 are contacted with the base 11. The limiting hole 132 is corresponded to the hole 111. In this embodiment, the base 11 and the bending portion 12 are made from ion-polymerized resin (surlyn).

When the fastener 1 is used for binding the first object 2 and the second object 3, a fixing component 4 such as a screw or a rivet is used to combine the first object 2 with the base 11 and the plate body 13 first, and then bending the bending portion 12 from the base 11, such that the bending portion 12 is expanded outward, and the second object 3 is disposed in the through hole 14. The second object 3 is constrained and fixed to the through hole 14 when the bending portion 12 is pressed upward and restored to its original position. Therefore, the fastener 1 can bind the first object 2 and the second object 3 easily and tightly by bending the bending portion 12 directly without any assistance of a tool, thus facilitating the assembling process.

Besides, the stopping portion 115 can be used for limiting the second object 3 to prevent its slipping from the first object 2.

When users want to separate the first object 2 and the second object 3, the bending portion 12 can be expanded outward by bending the bending portion 12 away from the base directly, so that the fastener 1 no longer constrains the second object 3, and the second object 3 can be separated from the fastener 1 without any assistance of a tool.

Besides, the bending portion 12 provides the dots 121, therefore the supporting capability can be enhanced, thus the situation of a breakdown of the fastener 1 or a separation of the second object 2 from the first object 3 can be prevented when the second object is impacted by a baseball or a softball traveling at a set speed such as 60 rpm.

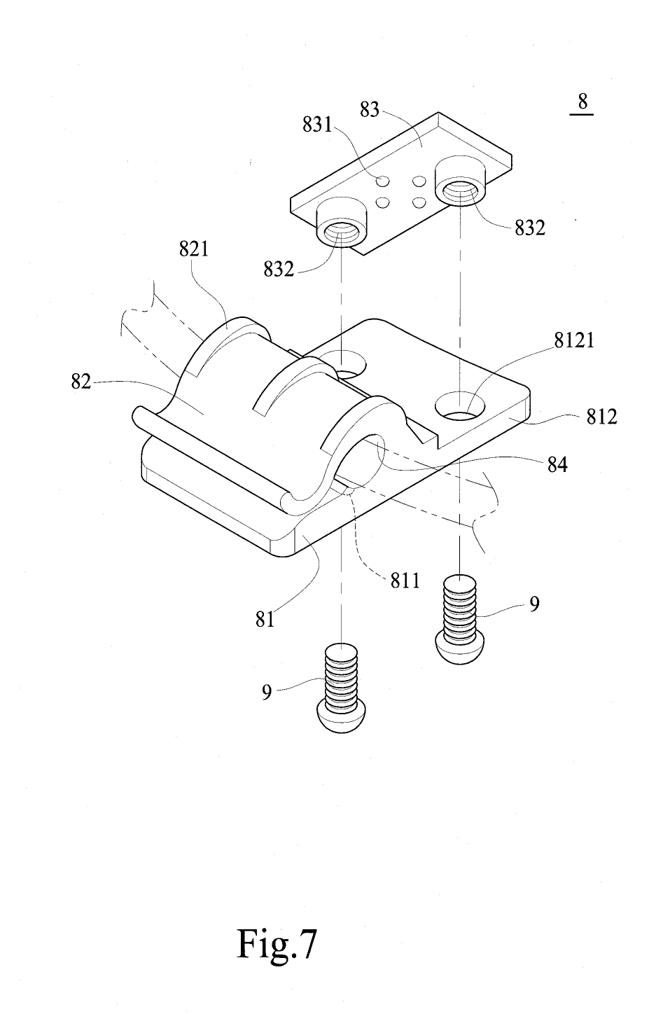

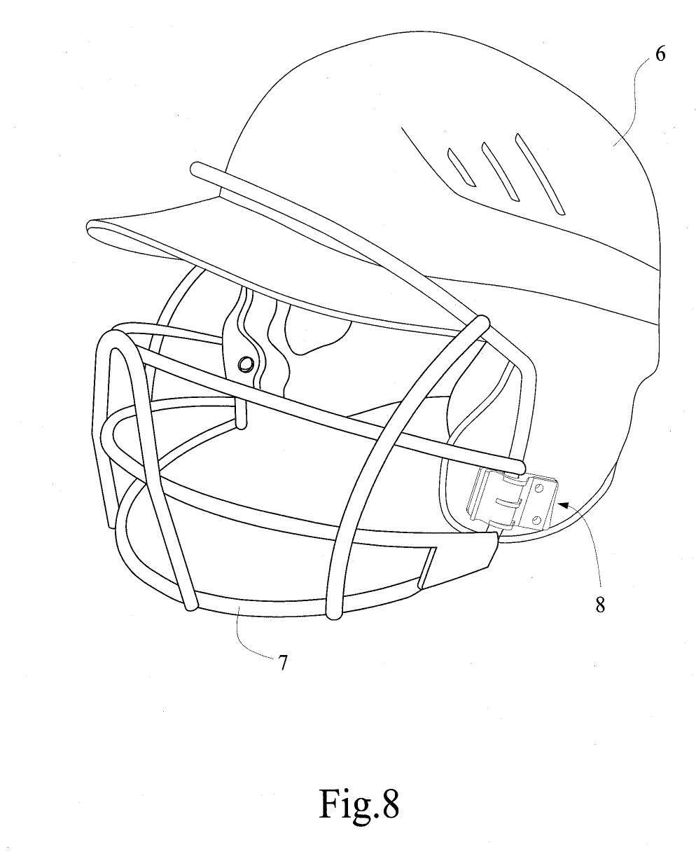

With reference to FIGS. 7 and 8 for an exploded view and a perspective view of a fastener in accordance with a second embodiment of present invention respectively, the first object 6 is a helmet, and the second object 7 is a mask, but the present invention is not limited thereto. The fastener 8 comprises a base 81, a bending portion 82, a plate body 83 and a through hole 84. Besides, the base 81 further includes a stopping portion 811. The bending portion 82 includes a plurality of ribs 821, and the plate body 83 includes a plurality of dots 831 and two limiting holes 832. Since the structure and function of the bending portion 82 and the through hole 84 of this embodiment are the same as the first embodiment, thus they will not be described here again.

The difference between this embodiment and the first embodiment is that the base 81 further comprises an extending portion 811 extended from one side of the base 81, and the extending portion 811 are provided with two holes 8121. The plate body 83 is disposed on the extending portion 811, and the plate body 83 and the extending portion 811 are bounded together by a fixing component 9.

Besides, the width of the base 81 of the present invention is wider than the base 81 of the first embodiment, and thus the first object 7 and the second object 8 can be bounded tightly by only two fasteners with a higher clamping capability.

In summation of the forgoing description, the fastener according to the present invention provides the effect of binding the first object and the second object together or separating them from each other by bending the bending portion of the faster without any assistance of a tool, so as to facilitate assembling process and reduce processing time.

The fastener according to the present invention also provides another effect of using the bending portion provided with a plurality of ribs to reinforce the supporting capability of the fastener, so as to prevent the fastener from being broken or the mask from being separated from the helmet when the fastener is impacted by a softball or a baseball.

The present invention improves over the prior art and complies with patent application requirements, and thus is duly filed for the patent application. While the invention has been described by device of specific embodiments, numerous modifications and variations could be made thereto by those generally skilled in the art without departing from the scope and spirit of the invention set forth in the claims.

What is claimed is:

1. A fastener, for coupling a first object being a helmet and a second object being a mask, and the fastener comprising:
a base, for coupling the first object;
a bending portion, extending curvably from one side of the base; and
a through hole, formed between the base and the bending portion;
wherein the second object is fitted into the through hole by bending the bending portion away from the base so as to expand the bending portion outward, and the second object is clamped by the bending portion when the bending portion is restored to its original state.

2. The fastener of claim 1, wherein the base comprises a stopping portion projecting from one side of the base to the through hole.

3. The fastener of claim 1, further comprising a plate body made of metal disposed on one side of the base, and one end of the plate body being extended to one side of the plate body.

4. The fastener of claim 3, wherein the plate body includes a plurality of dots disposed on one side of the plate body, and the dots are in contact with the base.

5. The fastener of claim 1, wherein the base further comprises an extending portion having a plurality of holes.

6. The fastener of claim 1, wherein the base and the bending portion are made of nylon or ion-polymerized resin (surlyn).

7. A fastener, for coupling a first object being a helmet and a second object being a mask, and the fastener comprising:
a base, including a hole and a stopping portion, the base being engaged with the first object by a fixing component passing through the hole, and the stopping portion projecting from one side of the base to the through hole;
a bending portion, extended from one side of the base in a curved U shape and including a plurality of ribs, and one side of the bending portion warping away from the base;
a through hole, formed between the base and the bending portion;
wherein the second object is fitted into the through hole by bending the bending portion away from the base so as to expand the bending portion outward, and the second object is clamped by the bending portion when the bending portion is restored to its original state.

8. The fastener of claim 7, further comprising a plate body made of metal and disposed on one side of the base, and one end of the plate body extending to one side of the plate body.

9. The fastener of claim 8, wherein the plate body includes a plurality of dots disposed on one side of the plate body, and the dots are in contact with the base.

10. The fastener of claim 8, wherein the plate body further includes a limiting hole corresponding to the hole, and the fixing component is extruded to the limiting hole.

11. The fastener of claim 7, wherein the base and the bending portion are made of nylon or ion-polymerized resin (surlyn).

12. A fastener, for coupling a first object and a second object, comprising:
a base, including a hole, a stopping portion and a limiting hole, and the base being engaged with the first object by a fixing component passing through the hole, and the stopping portion projecting from one side of the base to the through hole, and the limiting hole corresponding to the hole, and the fixing component being protruded into the limiting hole;
a bending portion, extended from one side of the base in a curved U shape and including a plurality of ribs, and one side of the bending portion warping away from the base;
a plate body, made of metal and disposed on one side of the base, and one end of the bending portion being extended to one side of the plate body; and
a through hole, formed between the base and the bending portion;
wherein the second object is fitted into the through hole by bending the bending portion away from the base so as to expand the bending portion outward, and the second object is clamped by the bending portion when the bending portion is restored to its original state.

13. The fastener of claim 12, wherein the plate body includes a plurality of dots disposed on one side of the plate body, and the dots are in contact with the base.

14. The fastener of claim 12, wherein the base and the bending portion are made of nylon or ion-polymerized resin (surlyn).
